(19) United States
(12) Patent Application Publication
(10) Pub. No.: US 2010/0110335 A1
(43) Pub. Date: May 6, 2010

(54) Display unit with improved backlighting

(76) Inventor: Roar Viala, Banyuls Surmer (FR)

Correspondence Address: James A. Gavney Jr.;JAG Patent Services LLC, Suite 21, 1901 Old Middlefield Way, Mountain View, CA, 94043, US

(21) Appl. No.: 12/290,834

(22) Filed: Nov. 4, 2008

(51) Int. Cl. G02F 1/13357

(52) U.S. Cl. 349/64; 349/65

(57) ABSTRACT

A display unit is disclosed that includes a liquid crystal panel and a backlighting panel. The backlighting panel includes a front light emitting surface patterned with pixels and a back reflective surface. The display unit also includes a controllable light source, that preferably includes light emitting diodes that transmit light into the backlighting panel through side wall of the backlighting panel. The display unit is preferably used in portable electronic devices, such as personal digital assistants (PDAs), cellular phones and digital entertainment systems.

### FIELD OF THE INVENTION

This invention relates to displays. More specifically, this invention relates to liquid crystal displays with backlighting.

### BACKGROUND

Backlighting refers to illumination used in a liquid crystal displays (LCD). Backlighting is often used in small displays such as mobile phone displays to help increase readability in low light conditions. Backlighting is also used in computer displays and LCD televisions. The backlighting used in LCDs typically accounts for more than 80 percent of the display power consumption and can quickly deplete a charged battery. For mobile electronic devices, such as cell phones, PDAs and portable enthronement systems, battery lifetime is of great importance. Accordingly, there has been advances in producing batteries with longer life times as well as developing devices with lower rates of power consumption.

The present invention is directed to a display unit that is particularly well suite for mobile electronic devices. The display unit of the present invention exhibits improved light output efficiency and, therefore, can be operated at a reduced rate of power consumption.

### SUMMARY

The present invention is directed to a display unit that includes a liquid crystal structure with a liquid crystal panel and any optical elements or films suitable for the application at hand. For example the liquid crystal panel is coated with one or more of a protective layer and an optical diffuser layer. The liquid crystal panel has light receiving surface and a display surface.

The display unit further includes a backlighting structure that eclipses at least a portion of the liquid crystal structure. The backlighting structure includes a backlighting panel with a front light emitting surface and a back reflective surface. The front light emitting surface of the backlighting structure is preferably patterned with hexagonal shaped pixels, which occupy greater than 80% or more of the light emitting surface. The back reflective surface is preferably coated with a reflective material, patterned with a matte surface and/or a combination thereof.

The display unit of the present invention is particularly well suited for displays used in portable electronic devices, such as personal digital assistants (PDAs), cellular phones and digital entertainment systems. However, it will be clear to one skilled in the art from the description below that the display unit of the present invention has applications for use computer monitors, television screens and any other device where backlighting is preferred or required to display images from a liquid crystal panel. In a particular embodiment of the invention, the display unit is used to provide lighting for a head mounted display that is for example mounted to a user's head through a frame, similar to a frame used for corrective eye glasses.

The display unit, or backlighting structure, also includes a light source or light sources that are placed around periphery edges of the backlighting panel. The backlighting panel is formed from a glass material, a polymeric material or any other material with that is capable of transmitting light. The light source or light sources are configured to transmit light into the backlighting panel through side walls of the backlighting panel. In operation a portion of the light is emitted through the hexagonal shaped pixels and onto the liquid crystal panel.

Preferably, the light transmitted from the light source or light sources and into the backlighting panel is transmitted to the onto the liquid crystal panel with en efficiency of 80% or greater.

Suitable light sources include, but are not limited to, incandescent light sources, light emitting diode light sources, electro-luminescent light sources and flourescent light sources. The liquid crystal panel is a thin-film transistor (TFT) liquid crystal panel, an in-plane switching (IPS) liquid crystal panel, a multi-domain vertical alignment (MVA) crystal panel, a patterned vertical alignment (PVA) crystal panel, a continuous pinwheel alignment (CPA) crystal panel or any combination thereof.

The display unit in further embodiments of the invention further includes one or more optical diffuser layers, one or more optical polarizer layers and or any other optical element suitable for the application at hand. The one or more optical elements are, for example, sandwiched between the liquid crystal structure and the backlighting structure.

The display unit in accordance with the embodiments of the invention further includes means for controlling an output of the light source and/or images displayed on the display unit. For example, the means for controlling an output of the light source and/or images displayed on the display unit includes a micro processor and/or receiver, such as a radio receiver, for receiving the dynamic media data from a transmitting device. Where the display unit includes a receiver, the display unit is configured to display a representation of the dynamic media data.

### BRIEF DESCRIPTION OF DRAWINGS

FIG. 1A shows a cross-sectional view of a backlighting construction used in LCD displays.

FIG. 1B shows a cross-sectional view of a backlighting construction used in LCD displays, in accordance with the embodiments of the present invention.

FIGS. 2A-B show a cross-sectional view of a backlighting construction and a front top view of backlighting panel used in LCD displays, in accordance with the embodiments of the present invention.

FIG. 3A illustrates a schematic representation of an LCD display unit with a control unit, in accordance with the embodiments of the present invention.

FIG. 3B illustrates a portable electronic device with LCD display unit shown in FIG. 3A.

FIG. 4 is a block-flow diagram outlining the steps for making a device with a display unit, in accordance with the method of the present invention.

FIG. 5 shows a graphical representation comparing light output from a display using backlighting of the present invention to that of a display using convention backlighting.

FIG. 6 shows a schematic representation a head mountable system that includes display units of the present invention.

### DETAILED DESCRIPTION

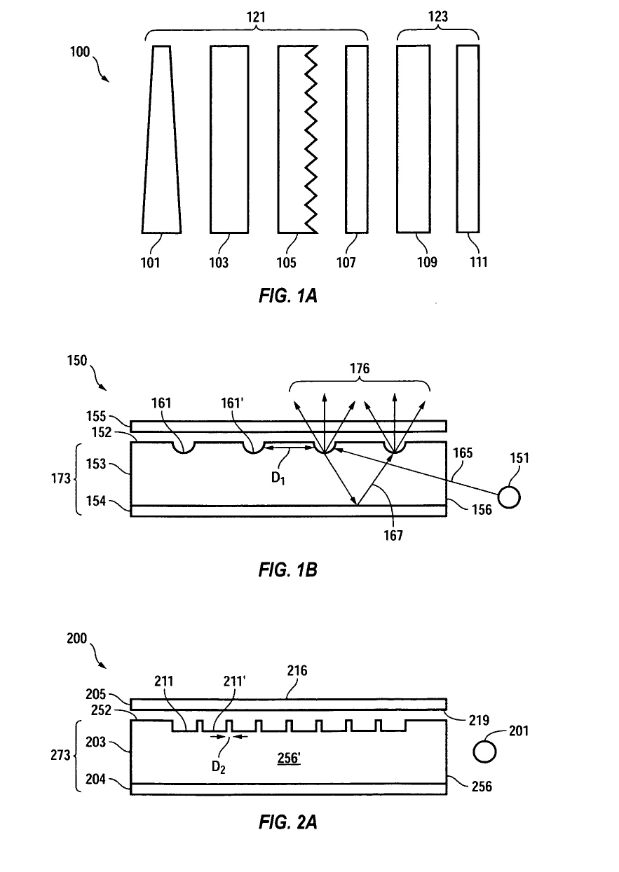

FIG. 1A shows a cross-sectional view of a liquid crystal display configuration 100 with and liquid crystal structure 123 and a backlighting structure 121. The backlighting structure 121 includes a light source 101, a diffuser 103, a prism 105 and a polarizer 107. The backlighting structure 121 is eclipsed, or partially eclipsed with the liquid crystal structure 123. The liquid crystal structure 123 includes a liquid crystal panel 109 with one more optical elements or optical films 111 to optically enhance or modify an image produced by the liquid crystal display configuration 100. The liquid crystal display configuration 100 is too bulky to be suitable for use in very thin or small portable electronic devices. In order to reduce the space required for a liquid crystal display in very thin or small portable electronic devices, a liquid crystal display configuration with an in-plane backlighting structure, such as described below with reference to FIG. 1B, is preferable.

FIG. 1B shows a liquid crystal display configuration 150 that utilize an in-plane backlighting structure 173. The term “in-plane backlighting structure” refers to a back lighting structure with a backlighting panel 153 and one or more light sources 151 positioned around a parameter or periphery of the backlighting panel 153. The liquid crystal display configuration 150 also includes a liquid crystal structure 155 that includes a liquid crystal panel. As described above, the backlighting structure 153 and the liquid crystal structure 155 are at least partially eclipsed. Also, the backlighting structure 153 and the liquid crystal structure 155 include any number of optical elements or films suitable for the application at hand.

Still referring to FIG. 1B, the backlighting panel 153 includes a light emitting surface 152 and a reflective back surface 154. The light emitting surface 152 is patterned with pixels 161 and 161′ that are separated by a distance D₁, which occupies less than 80% of the light emitting surface 152. In operation, the one or more light sources 156 emits light, as indicated by the arrow 165. The light that is emitted by the one or more light sources 156 enters into the backlighting panel 153 through side walls 156 of the back lighting panel 153. The back lighting panel 153 acts as a wave guide and a portion of the light tunnels through the backlighting panel 153 and strikes the pixels 161 and 161′. The pixels bend the light and cause the light to be emitted through the backlighting panel 153 from the light emitting surface 152 as indicated by the arrows 176. Portions of the light 165 are internally reflected from the back reflective surface 154, and other structure interfaces within backlighting panel 153 before being emitted from the light emitting surface 152. The light emitted from the light emitting surface 152 strike the liquid crystal structure to produce an image and/or enhance brightness of an image on a liquid crystal structure 155.

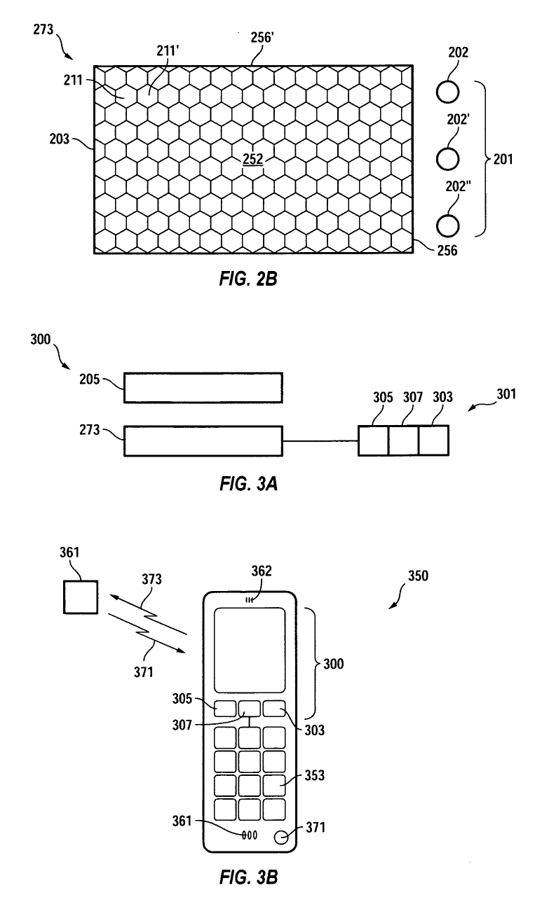

Now referring to FIG. 2A, in a preferred embodiment of the invention, a display unit 200 includes a liquid crystal structure 205 with a light receiving surface 219 and a display surface 216. The liquid crystal structure 205 includes a liquid crystal panel that is a thin-film transistor (TFT) liquid crystal panel, an in-plane switching (IPS) liquid crystal panel, a multi-domain vertical alignment (MVA) crystal panel, a patterned vertical alignment (PVA) crystal panel, a continuous pinwheel alignment (CPA) crystal panel or any combination thereof. The liquid crystal structure 205 also includes any number of optical elements or optical films suitable for the application at hand.

Still referring to FIG. 2A, the display unit 200 further includes a backlighting lighting structure 273 that is at least partially eclipsed with a portion of the liquid crystal structure 205. The backlighting structure 173 includes a backlighting panel 203 with a front light emitting surface 252 and a back surface reflective 204. The backlighting panel 203 is formed from a glass material, a polymeric material or any other material with that is capable of transmitting light.

Referring now to both FIGS. 2A and 2B front light emitting surface 205 of the backlighting panel 203 is preferably patterned with hexagonal shaped pixels 211 and 211′, wherein the hexagonal shaped pixels 211 and 211′ occupy 80% or more of the light emitting surface 252. Here and throughout the application, the same reference numbers are used for labeling similar or the same elements in separate Figures. The hexagonal shaped pixels 211 and 211′ are preferable speared by a distance D₂.

The back reflective surface 204 of the backlighting panel 203 is coated with a reflective material, patterned with a matte surface and/or otherwise modified to allow light that enters into the backlighting panel 203 to be internally reflected, such as described previously with reference to FIG. 1B. For example, the back reflective surface 204 is coated with a reflective paint, a mirror film and/or a matte film.

The backlighting structure 173 also includes a light source or light sources 201 that are placed around one or more edges of the backlighting panel 203 and are configured to transmit light through one or more side walls 256 and 256′ of the backlighting panel 203, such as described above with reference to FIG. 1B. The one or more light sources 201 include electro-luminescent light sources, flourescent light sources or a combination thereof. Preferably, the one or more light sources 201 include a plurality of light emitting diodes 202, 202′ and 202″ positioned around the entire periphery of the backlighting panel 203.

In operation a portion of the light emitted by the light source or light sources 201 is transmitted though the one or more side walls 256 and 256′ of the backlighting panel 203. The light is then emitted through the hexagonal shaped pixels 211 and 211′ and onto the light receiving surface of the liquid crustal structure 205 to generate or enhance an image produced on the a display surface 216 of the liquid crystal structure 205. Preferably, the light is transmitted to the onto light receiving surface 219 liquid crystal structure 205 is transmitted from the light source or light sources 201 with an efficiency of 80% or greater.

Now referring to FIG. 3A, a display unit 300 in accordance with the embodiments of the invention includes a liquid crystal structure 205 and a backlighting structure 273, such as described in detail above. The display unit further includes control means 301 for controlling an output of a light source and/or images displayed on the display unit 300. The control means 301 includes a micro processor 307, a receiver 305 and a transmitter 303 for receiving and transmitting dynamic media data. In accordance with this embodiment, the display unit 300 is configured to display a representation of the dynamic media data received by the receiver 305 and/or transmitted by the transmitter 303.

In accordance with a specific embodiment of the invention a cellular phone 350 includes the display unit 300. The cellular phone is configured to receiving the dynamic media data, as indicated by the arrow 371 from a remote device 361, such as another cellular phone, and is configured to transmit dynamic media data, as indicated by the arrow 373, to the remote device 361. The cell phone 350 preferably includes one or more user interfaces for imputing dynamic media data. Suitable user interfaces include, for example, a key pad 353, a micro-phone 361 and a camera 371. The cellular phone 350 also includes a speaker 362 for receiving an audio representation of dynamic media data received by the receiver 305 and transmitted from the remote device 361.

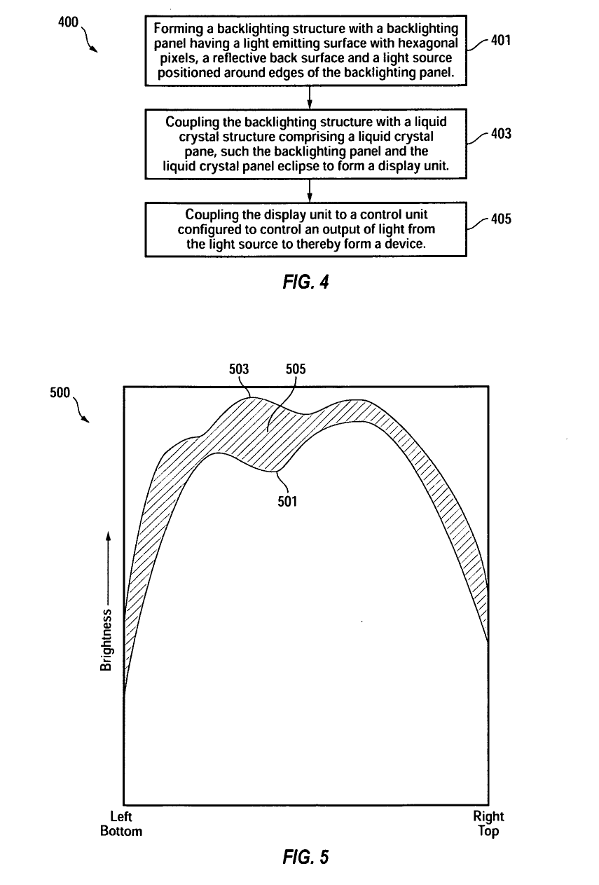

FIG. 4 is a block-flow diagram 400 outlining the steps for making a device with a display unit, in accordance with the method of the present invention. In the step 401a backlighting structure with a backlighting panel having a light emitting surface with hexagonal pixels, a reflective back surface and a light source positioned around edges of the backlighting panel is formed. The backlighting structure is formed using any suitable method including injection molding and lithographic and/or embossing techniques. In the step 403, the backlighting structure formed in the step 401 is coupled to a liquid crystal structure comprising a liquid crystal panel, such that backlighting panel and the liquid crystal panel are at least partially eclipsed to form a display unit. After the display unit is formed in the step 403, in the step 405 the display unit is coupled to a control unit configured to control an output of light from the light source to thereby form a device. The control unit includes a micro processor, receiver, a transmitter (or transducer) and any number of user interfaces, such as described with reference to the cellular phone device 350 in FIG. 3B

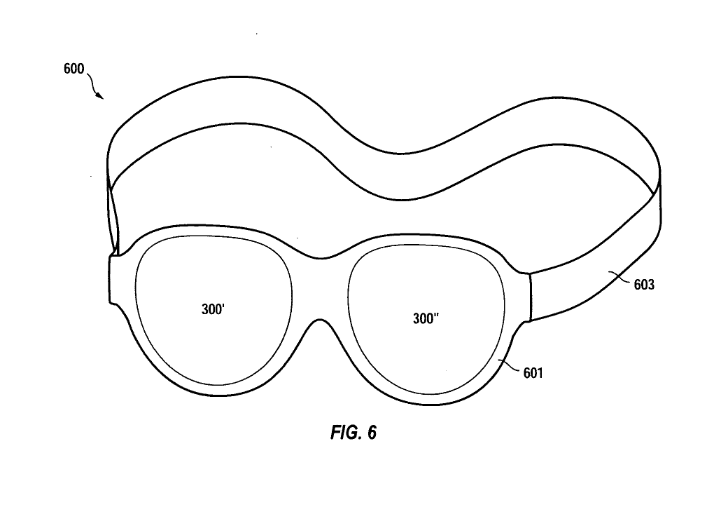

FIG. 5 shows a graphical representation 500 comparing light output from a display using backlighting configuration of the present invention as indicated by the line 503 to that of a display using convention backlighting, as indicated by the line 501. Both of the lines 503 and 501 represent the brightness measurements of rectangular displays acquired diagonally across the rectangular displays from the left bottom corner to the top right corner of the rectangular displays while operating at the same rate of power consumption. Note that the hatched area 505 between the curves 503 and 501 represents the improvement in efficiency achieved by the backlighting configuration of the present invention.

While the display unit of the present invention been described as being used for displaying media data on small or thin portable small electronic devices, such as personal digital assistants (PDAs), cellular phones and digital entertainment systems, the display unit of the present invention also has applications for use in computer monitors, television screens and any other device where backlighting in required to display images.

Referring now to FIG. 6, in a particular embodiment of the invention back lighting structures 300′ and 300″ similar to the back lighting structure 273 described with reference to FIGS. 2A and 2B are used to provide back lighting or lighting for display 600 that is configured to be mounted to a user's head through a frame 601, with a strap 603 or other suitable means.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A display unit comprising:
a) an liquid crystal structure comprising a liquid crystal panel with a light receiving surface and a display surface;
b) a backlighting structure comprising a backlighting panel, wherein the backlighting structure eclipses at least a portion of the liquid crystal structure and wherein the backlighting panel has a front light emitting surface that is patterned with hexagonal shaped pixels and a back reflective surface; and
c) a light source positioned around edges of the backlighting panel
wherein the light source is configured to transmit light into the backlighting panel through sides of backlighting panel and emitted a portion of the light through the hexagonal shaped pixels and onto the light receiving surface of the liquid crystal panel.

2. The display unit of claim 1, wherein back reflective surface of the backlighting panel is a matte surface.

3. The display unit of claim 1, wherein the light source comprises one or more of an incandescent light source, a light emitting diode light source, an electro-luminescent light source and a flourescent light source.

4. The display unit of claim 1, wherein the liquid crystal panel is a thin-film transistor (TFT) liquid crystal panel, an in-plane switching (IPS) liquid crystal panel, a multi-domain vertical alignment (MVA) crystal panel, a patterned vertical alignment (PVA) crystal panel, a continuous pinwheel alignment (CPA) crystal panel or a combination thereof.

5. The display unit of claim 1, further comprising one or more optical diffuser layers.

6. The display unit of claim 1, further comprising one or more optical polarizer layers.

7. The display unit of claim 1, wherein the backlighting panel is formed from a glass material or a polymeric material.

8. The display unit of claim 1, wherein the display surface of the liquid crystal panel is coated with one or more of a protective layer and an optical diffuser layer.

9. The display unit of claim 1, further comprises a controlling means for controlling an output of the light source.

10. A display comprising:
a) a liquid crystal panel with a light receiving surface and a display surface;
b) a backlighting panel in eclipsing at least a portion of the liquid crystal panel, the backlighting panel comprising a front light emitting surface and a back reflective surface, wherein the wherein back reflective surface of the backlighting panel is a matte surface; and
c) a light emitting diode light source placed around edges of the backlighting panel, which is configured to transmit light into the backlighting panel an portion of which is emitted through the hexagonal shaped pixels and onto the liquid crystal panel.
d) a control means for controlling an output of the light source.

11. The display of claim 10, wherein light emitting surface is patterned with hexagonal shaped pixels.

12. The display of claim 10, wherein the control means includes a micro processor.

13. The display of claim 12, wherein the control means includes a radio receiver for receiving the dynamic media data from a transmitting device and wherein the display unit is configured to display a representation of the dynamic media data.

14. The display of claim 10, further comprising one or more optical diffuser layers sandwiched between the liquid crystal panel and the backlighting panel.

15. The display of claim 14, further comprising one or more optical polarizer layers sandwiched between the liquid crystal panel and the backlighting panel.

16. The display of claim 10, wherein the backlighting panel is formed from a glass material or a polymeric material.

17. The display of claim 10, wherein the display surface of the liquid crystal panel is coated with one or more of a protective layer and an optical diffuser layer.

18. An electronic device comprising:
a) an liquid crystal display with a backlighting panel with hexagonal shaped pixels;
b) a light source for emitting light into the backlighting panel, wherein a portion of the light illuminates a liquid crystal panel through the hexagonal shaped pixels; and
c) a controlling means for controlling the light emitted from the light source.

19. The electronic device of claim 18, wherein the electronic device is selected from the group consisting of a cellular phone, a computer, portable entertainment device.
